(19) United States
(12) Patent Application Publication
(10) Pub. No.: US 2002/0104299 A1
(43) Pub. Date: Aug. 8, 2002

(54) Air filter screen

(76) Inventor: Yung-Yu Chang, Tainan Hsien (TW)

Correspondence Address: Cooper & Dunham LLP, 1185 Avenue of the Americas, New York, NY, 10036, US

(21) Appl. No.: 09/777,591

(22) Filed: Feb. 6, 2001

(51) Int. Cl. B01D 46/00

(52) U.S. Cl. 55/497; 55/501

(57) ABSTRACT

An air filter screen has a corrugated composite screen securely enclosed in a sectional frame. The sectional frame has two first beams respectively attached on first and third side-edges of the composite screen, two second beams respectively attached on second and fourth side-edges of the composite screen, and four right-angle connectors respectively combine the first beams together with the second beams, whereby the composite screen is enclosed in the combined sectional frame. When the composite screen needs to be replaced, the sectional frame is able to be separated, the old composite screen is detached from the opened sectional frame, and then after fitting a new composite screen with the sectional frame, the sectional frame is combined together again, so as to reduce cost of the air filter screen and help environmental protection.

### BACKGROUND OF THE INVENTION

1. Field of the Invention

The present invention relates to an air filter screen detachably assembled on an air filter, particularly to the air filter screen consisting of a composite screen enclosed in a sectional frame, which can be easily separated and/or combined together.

2. Description of Related Art

An internal combustion engine has an air inlet filter so as to clean the air being drawn in. However, the vehicle may have a first air filter fitted to the radiator at the front of the vehicle whereby air entering the hood of the vehicle is primarily cleaned before being drawn into the air inlet filter. The first air filter normally comprises an air filter screen used to extract dust, ashes and other particles. After being used for a time, the air filter screen becomes clogged with a lot of dust, ashes and other particles thereon, so that the air filter screen needs to be cleaned to ensure efficient filtration of the air.

As shown in FIGS. 6 and 7, one conventional air filter comprises a plane type air filter screen (30), which is securely enclosed in a square fixed frame (40). The air filter screen (30) consists of two sheets of retaining grids (31) made of metal and one sheet of metal mesh grid (32) sandwiched between the two retaining grids (31).

The aforesaid plane type air filter screen (30) has only a limited intake area defining holes (311) for filtration of air. In order to increase the intake area, a part of the air filter screen is also designed in a corrugated shape. However both the plane type and the corrugated type of the air filter screen are securely enclosed in a fixed frame. After the air filter screen has been used for a period and needs to be replaced, the air filter screen including the retaining grids (31) and the fixed frame (40) should be discarded together with the metal mesh grid (32). This is obviously a defect which increases both cost to the consumer and damage to the environment.

Therefore, it is an objective of the invention to provide an improved air filter screen to mitigate and/or obviate the aforementioned problems.

### SUMMARY OF THE INVENTION

The object of the present invention is to provide an air filter screen comprising a corrugated composite screen enclosed in a sectional frame. The sectional frame has two first beams respectively attached on opposite first and third side-edges of the composite screen, two second beams respectively attached on opposite second and fourth side-edges of the composite screen, and four right-angle connectors respectively combine the first beams with the second beams. Each one of the first beams has a groove defined therein to receive corresponding one of the first and third side-edges of the composite screen fitted therein, and two first sockets respectively defined in two opposite ends thereof. Each one of the second beams has a recess defined therein to receive corresponding one of the second and fourth side-edges of the composite screen fitted therein, and two second sockets respectively defined in two opposite ends thereof. Each one of the right-angle connectors has two plugs, which are perpendicular to each other and respectively inserted into the corresponding first and second sockets of the first and second beams, and a connecting portion integrally formed between the two plugs. Whereby the sectional frame can be easily assembled and dismantled, so that if the composite screen needs to be replaced, the sectional frame is dismantled by a user, after which an old composite screen is replaced by a new one, and the sectional frame is combined again. Because the sectional frame is retained for continuing use, the cost of the air filter is low, and it also contributes to the environmental protection.

The detailed features of the present invention will be apparent in the detailed description with appropriate reference to the accompanying drawings.

### BRIEF DESCRIPTION OF THE DRAWINGS

FIG. 1 is a perspective view of an air filter screen in accordance with the present invention;

FIG. 2 is an exploded perspective view of the air filter screen in accordance with the present invention;

FIG. 3 is a vertical cross sectional view of the air filter in accordance with the present invention;

FIG. 4 is a horizontal cross sectional view of the air filter screen in accordance with the present invention;

FIG. 5 is a schematic view of assembly of the air filter screen in accordance with the present invention;

FIG. 6 is a perspective view of a conventional air filter screen; and

FIG. 7 is an exploded perspective view of the conventional air filter screen.

### DETAILED DESCRIPTION OF THE PREFERRED EMBODIMENT

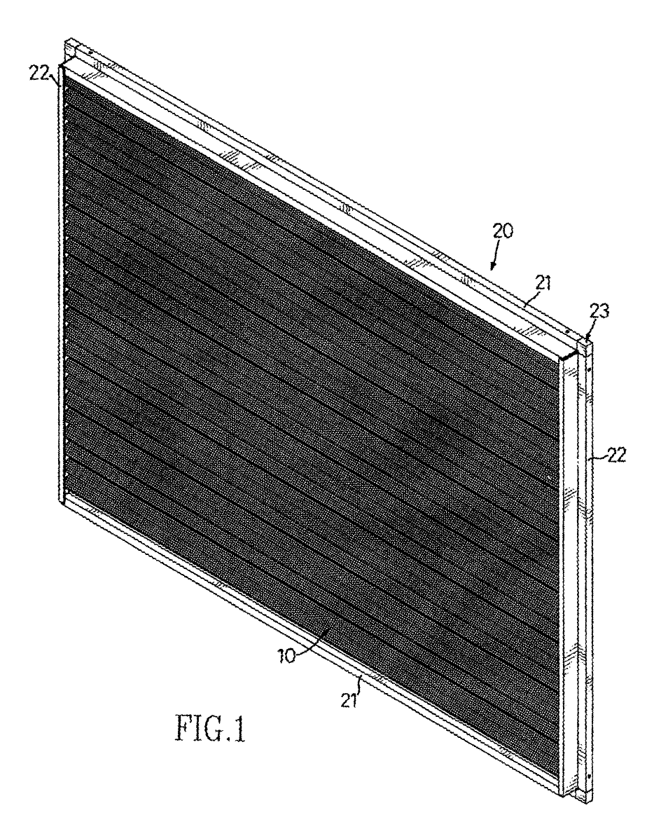

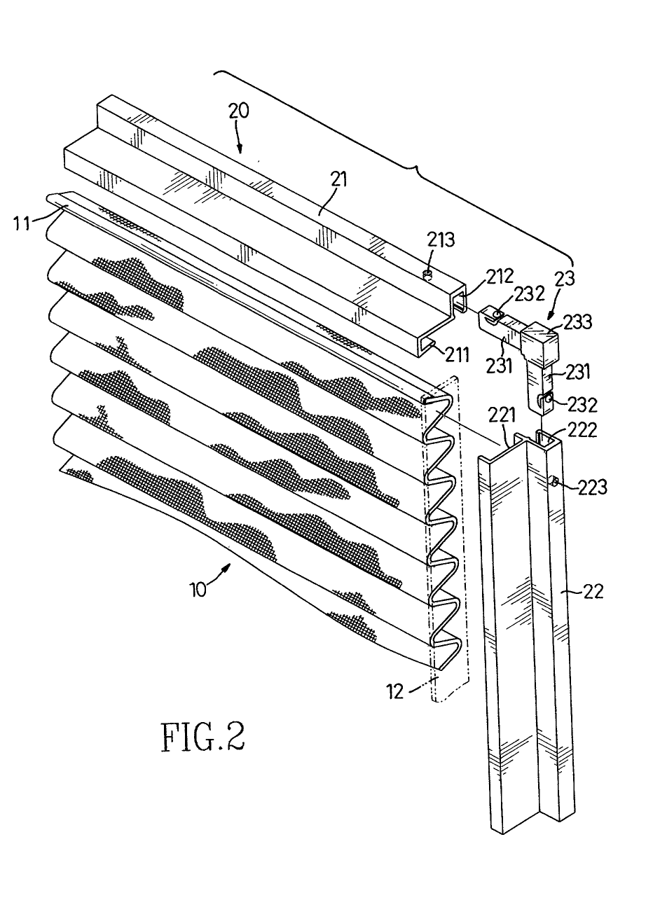

With reference to FIGS. 1 and 2, an air filter screen in accordance with the present invention comprises a corrugated composite screen (10) enclosed in a sectional frame (20).

The corrugated composite screen (10) consists of a screen sandwiched between two retaining grids made of metal. The composite screen (10) is formed in a square shape having opposite first and third side-edges parallel to extending direction of corrugations, and opposite second and fourth side-edges perpendicular to the extending direction of the corrugations. Two clips (11) are respectively fixed on the opposite first and third side-edges of the composite screen (10). Two reinforced plates (12) are respectively attached on the opposite second and fourth side-edges of the composite screen (10).

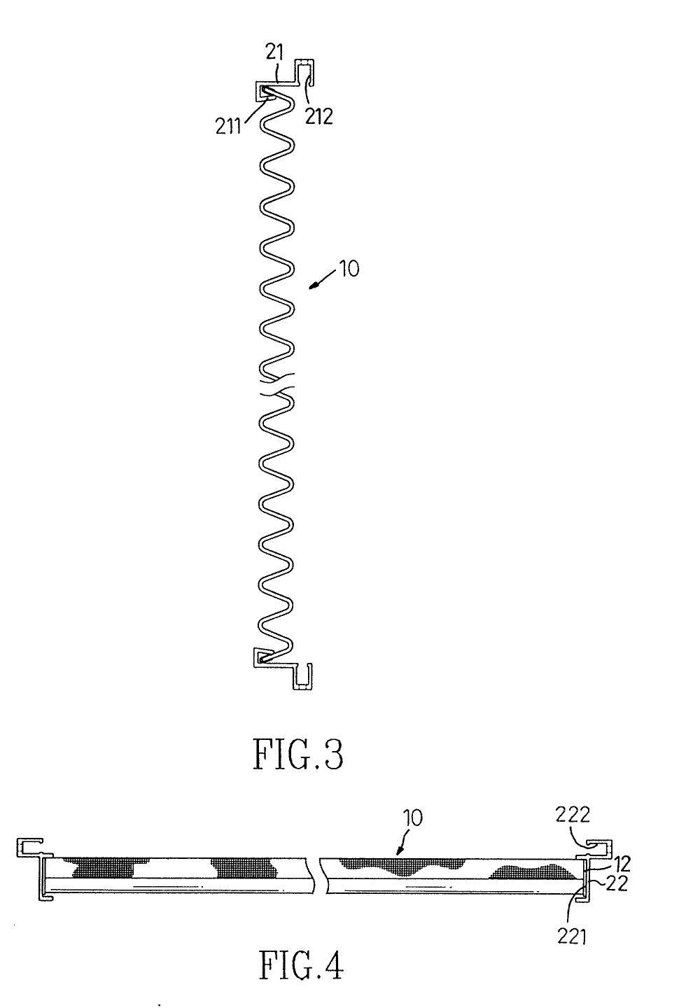

The sectional frame (20) comprises two first beams (21) respectively attached to the first and third side-edges of the composite screen (10), two second beams (22) respectively attached to the second and fourth side-edges of the composite screen (10), and four right-angle connectors (23) respectively provided at four right-angle corners of the frame (20). With further reference to FIG. 3, each one of the first beams (21) has a groove (211) defined therein to receive the clip (11) fitted therein, and two first sockets (212) defined in opposite ends thereof. Still referring to FIG. 2, each of the first beams (21) has two first fastening holes (213) defined near two opposite ends thereof and communicating with the first sockets (212). With reference to FIGS. 2 and 4, each of the second beams (22) has a recess (221) defined therein to receive the reinforced plates (12) fitted therein, and two second sockets (222) defined in opposite ends thereof. Each of the second beams (22) has two second fastening holes (223) defined near two opposite ends thereof and communicating with the second socket (222).

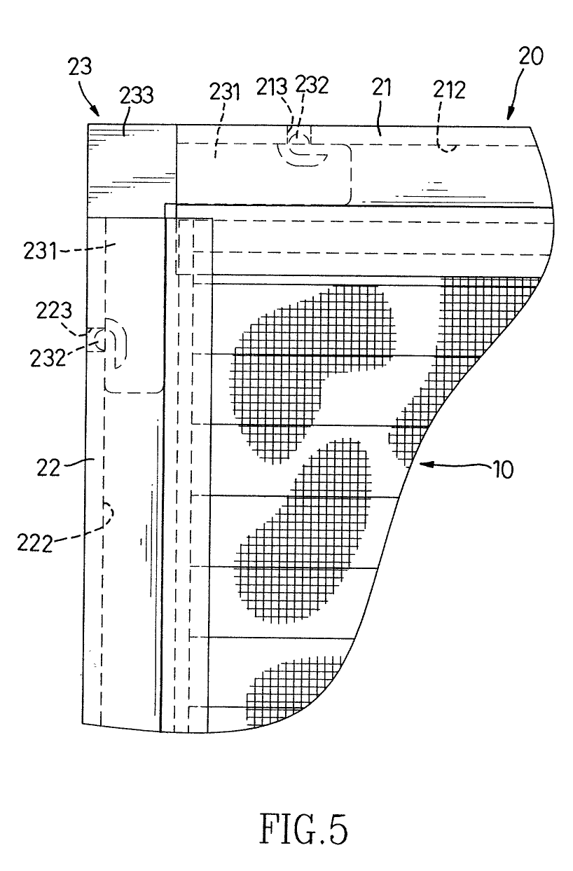

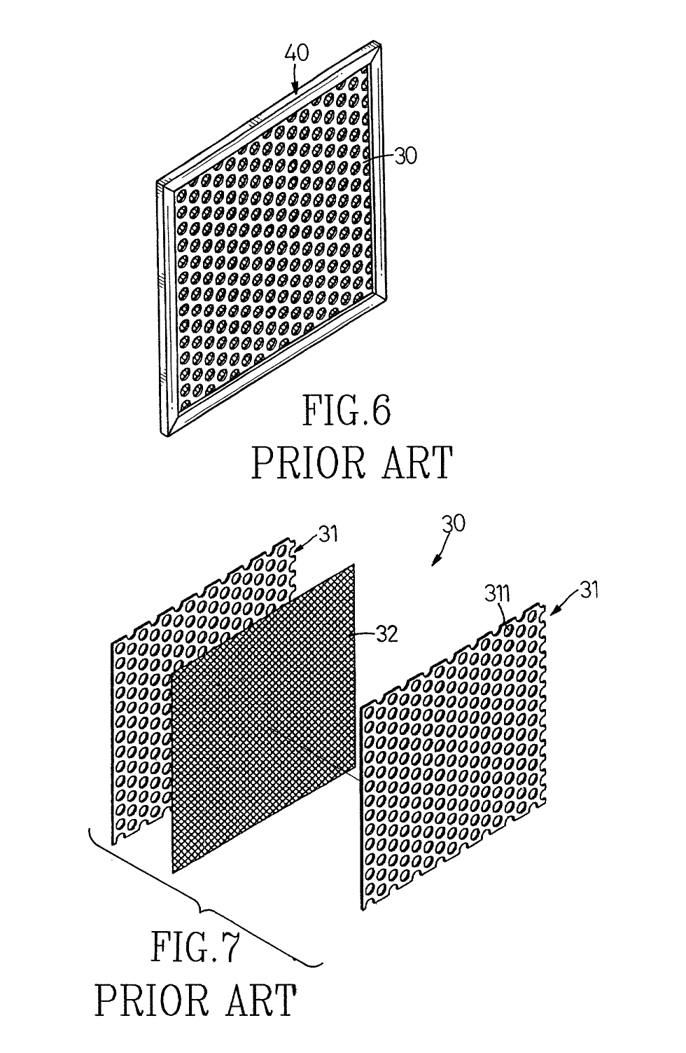

Each right-angle connector (23) is provided to connect the respective first and the second beams (21,22) and has two plugs (231) perpendicular to each other and a connecting portion (233) integrally formed between the two plugs (231). The plugs (231) of each of the right-angle connectors (23) are respectively formed with two elastic fasteners (232) corresponding to the first and second fastening holes (213, 223) of the first and second beams (21, 22). As clearly seen in FIG. 5, the plugs (231) of each right-angle connector (23) are respectively inserted into the corresponding first socket (211) of the first beam (21) and the corresponding second socket (222) of the second beam (22). The elastic fasteners (232) are respectively fitted into the corresponding first and second fastening holes (213, 223), such that the elements of the sectional frame (20) are combined and the air filter screen (10) is securely enclosed in the sectional frame (20).

When the air filter screen (10) needs to be replaced, the sectional frame (20) can be easily separated by a user who presses on the elastic fasteners (232) and draws out the plugs (231) from the first and second sockets (212, 222). That separation process is reversed when the new air filter screen (10) is fitted. The present invention has following advantages that:

1. as the elements of the sectional frame (20) are easily separated and assembled together without any tool, the screen of the air filter screen (10) is able to be replaced after being detached from the separated sectional frame (20), and the elements of the sectional frame (20) can be combined together again after a new composite screen is fitted thereto.

2. as the sectional frame (20) of the air filter can be continuously used, the cost of the air filter is low, and it does help the environmental protection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air filter screen comprises:
a composite screen with unidirectional corrugations and consisting of a screen sandwiched between two retaining grids, and formed with a square shape having a first side-edge and a third side-edge, the first and third side-edges being formed substantially parallel to an extending direction of the corrugations, and a second side-edge and a fourth side-edge, the second and fourth side-edges being formed substantially perpendicular to the extending direction of the corrugations;
a sectional frame including two first beams, which are respectively formed with two grooves to receive the first and third side-edges of the composite screen respectively fitted therein, and two second beams, which are respectively formed with two recesses to receive the second and fourth side-edges of the composite screen respectively fitted therein, two opposite ends of each one of the first and second beams being defined with two sockets; and
four right-angle connectors, each right-angle connector having two plugs perpendicular to each other and corresponding to the sockets of the first and second beams, and a connecting portion integrally formed between the two plugs; whereby
the plugs of the right-angle connectors are respectively inserted into the corresponding sockets of the first and second beams, such that the composite screen is securely enclosed in the sectional frame.

2. The air filter screen as claimed in claim 1, wherein each of the first and second beams is defined with two fastening holes communicating with the corresponding sockets near opposite ends thereof, the plugs of each of the right-angle connectors are respectively formed with two elastic fasteners corresponding to the fastening holes of the first and second beams, whereby when the plugs of the right-angle connectors are respectively inserted into the corresponding sockets of the first and second beams, the elastic fasteners are respectively fitted into the corresponding fastening holes.

3. The air filter screen as claimed in claim 1, wherein the first and the third side-edges of the composite screen are respectively fixed with two clips.

4. The air filter screen as claimed in claim 1, wherein the second and the fourth side-edges of the composite screen are respectively attached with two reinforced plates.
